(19) United States
(12) Patent Application Publication
(10) Pub. No.: US 2019/0255688 A1
(43) Pub. Date: Aug. 22, 2019

(54) BROKEN NIPPLE EXTRACTOR WRENCH

(71) Applicant: Woodbine Ventures, Inc., Airville, PA (US)

(72) Inventor: Ronald Darin Ingool, Airville, PA (US)

(73) Assignee: Woodbine Ventures, Inc., Airville, PA (US)

(21) Appl. No.: 15/898,764

(22) Filed: Feb. 19, 2018

(51) Int. Cl. B25B 27/18

(52) U.S. Cl. CPC B25B 27/18

(57) ABSTRACT

A wrench for extracting a broken nipple portion of what had been a threaded, male connector that had been screwed into a threaded, female, piping connector includes: (a) an elongated rod with an extraction head that has an outer surface with a free end that has a perimeter consisting of a plurality of sides that are joined together at intersection points, (b) a plurality of quasi-helical ridges, each of which emanates from an intersection point and winds itself in a left-handed, tapering outward manner around the head's outer surface, and (c) a deviation region in each of the quasi-helical ridges and adjacent to the points where a quasi-helical ridge passes through the head's transverse plane.

### BACKGROUND OF THE INVENTION

### 1. Field of the Invention

The present invention relates generally to the field of tools. For example, the present invention relates to an improved wrench or extractor tool for removing the broken portion of a pipe fitting that is screwed into a female, piping connector to such an extent that there is not enough of the broken fitting extending from the piping connector to allow one to grab onto the end of the broken fitting so as to rotate it counterclockwise to remove it from the piping connector. More particularly, the present invention relates to a wrench for removing from the female piping connector in a shower elbow a broken portion or nipple portion of the threaded end of a shower arm.

### 2. Description of the Related Art

It is not uncommon for the threaded end of a shower arm to become worn or damaged and, when exposed to excessive stress, to have a portion of this threaded end to break off inside a shower elbow's female piping connector into which the threaded end of the shower arm had been screwed. See FIG. 1.

When this broken off portion or broken nipple is not of sufficient length that some of it extends from the piping connector so as to allow one to grab its end and rotate it counterclockwise to remove the broken off portion, it can be very difficult to remove such broken off portions. Typically, a plumber would try to use either a file, a saw blade, needle nose pliers, etc. to remove such broken nipples. However, extraction methods using such tools can often result in damage to the shower elbow; even damage that is of such an extent that the shower elbow will then need to be replaced.

While there exist many types of nipple extraction tools (e.g., see U.S. Pat. Nos. 1,863,046, 2,013,923, 5,251,516, 7,152,509 and 8,955,415), none of these are sized so as to be, without some modification, effective at removing from a shower elbow a broken portion of the threaded end of a shower arm.

Thus, a need exists for a tool that can quickly and efficiently remove from a shower elbow's female connector, without damaging the shower elbow, the broken portion of the threaded end of a shower arm when that broken portion is not of sufficient length that some of it extends from the piping connector to allow one to grab onto the end of the broken fitting so as to then just rotate it counterclockwise to remove it from the piping connector.

### BRIEF DESCRIPTION OF THE DRAWINGS

FIG. 1 is an illustration of a shower elbow into which is screwed the threaded end of a shower arm; which if it were to be broken so that only a nipple portion of it remained in the shower elbow, the present invention would be the optimum tool with which to remove the nipple.

FIG. 2 is a perspective view of the wrench or extractor tool of the present invention being used to remove from a shower elbow's female connector the broken portion of the threaded end of a shower arm.

FIG. 3 is a perspective view of a preferred embodiment of the present invention.

FIG. 4 is a free end view of a stylized, extraction head that has symmetrical-around-its-perimeter, helical ridges and grooves and exhibits a backdraft portion on the far-right side of its perimeter.

FIG. 5 is a side view of the stylized extraction head shown in FIG. 4.

FIG. 6 is perspective, left-side view of the extraction head of the present invention that shows its free end and the intersections of its seven sides from which emanate its quasi-helical ridges and examples of their “deviation regions”

FIG. 7 is a side view of the extraction head shown in FIG. 6 that shows some of the “deviation regions” of its quasi-helical ridges.

FIG. 8 is perspective, right-side view of the extraction head shown in FIG. 6 that shows its free end and the intersections of its seven sides from which emanate its quasi-helical ridges and examples of their “deviation regions.”

FIG. 9 is a side view of the extraction head and rod of the wrench or extractor tool of the present invention that shows some of the “deviation regions” of its quasi-helical ridges.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention generally relates to an improved wrench or extractor tool for removing the broken portion of a pipe fitting that is screwed into a female, piping connector. The nature of this break is assumed to be such that there is not enough length to the broken fitting or nipple extending from the piping connector to allow one to grab onto its end so as to rotate the broken nipple counterclockwise to remove it from the piping connector. More particularly, the present invention relates to a wrench for removing, from the female piping connector in a shower elbow, the broken portion of the threaded end of a shower arm.

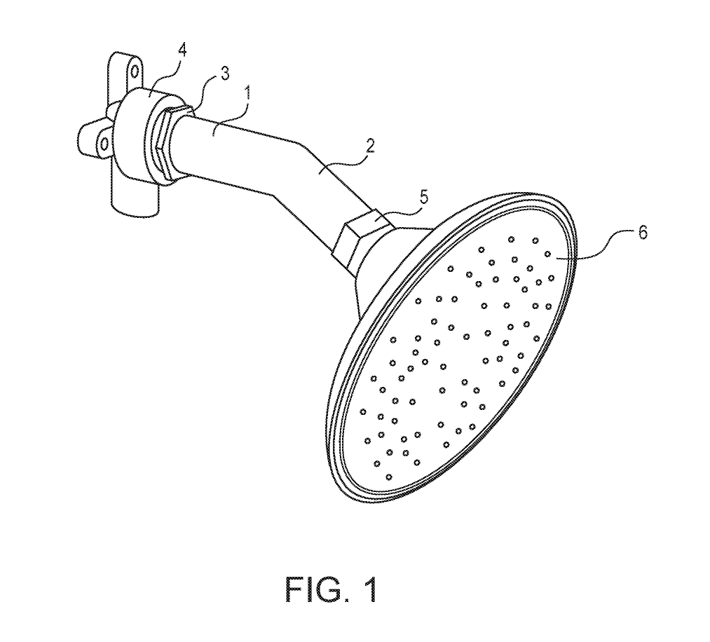

FIG. 1 shows a schematic representation of the standard setup when the threaded, proximal end 1 of a shower arm 2 is screwed into the female connector 3 of a shower elbow 4 and the distal end 5 of the shower arm is connected to a shower head 6.

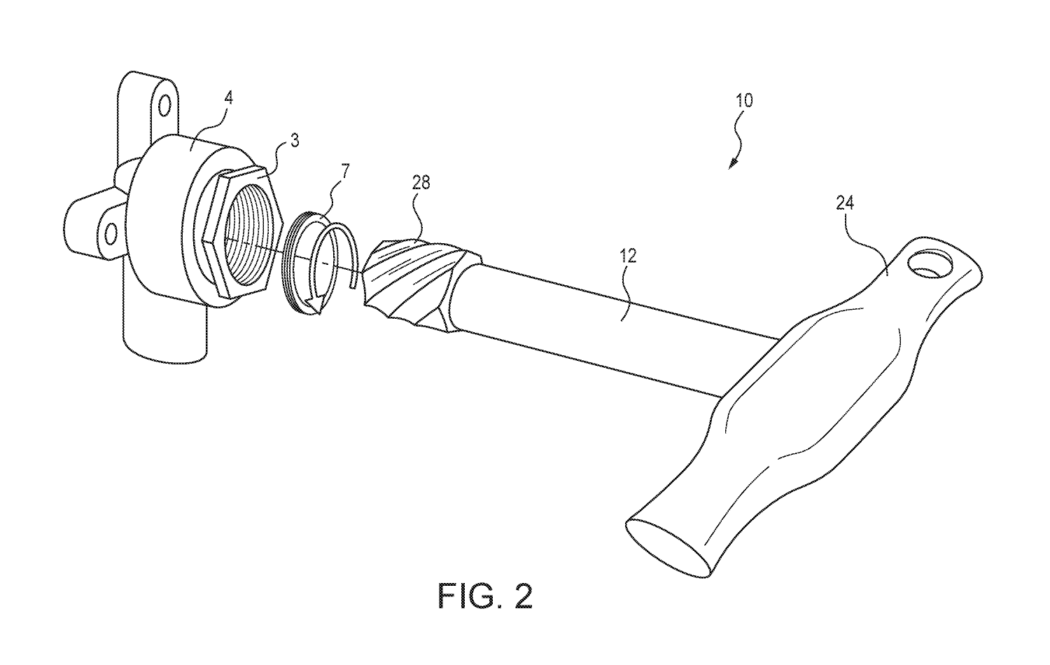

FIG. 2 is a perspective view of the wrench or extractor tool 10 of the present invention that has just been used to remove from a shower elbow's female connector 3 the broken nipple 7 of the threaded end of a shower arm 2.

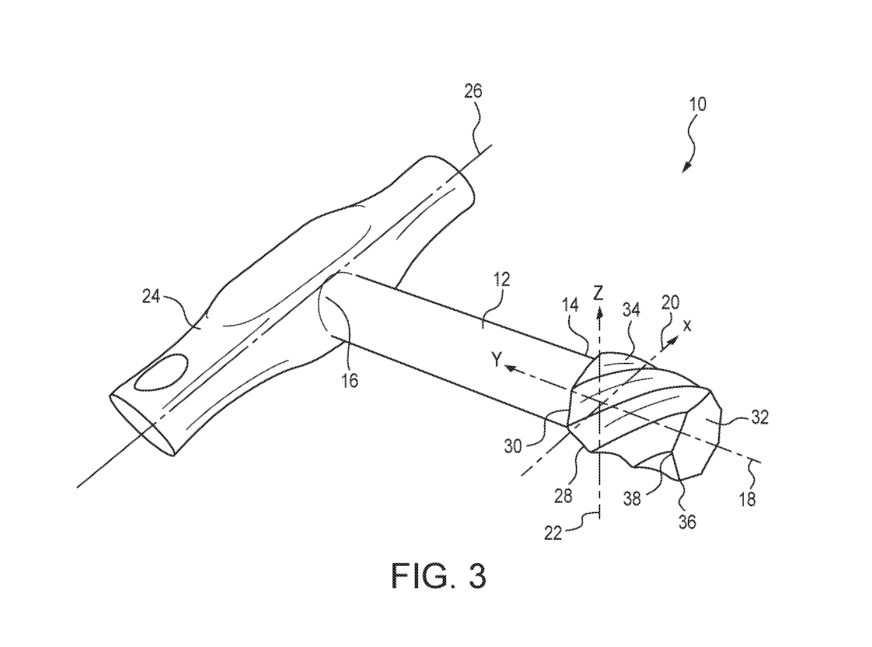

FIG. 3 is a perspective view that shows in more detail the wrench or extractor tool 10 of the present invention. It is seen to consist of an elongated rod 12 having proximal 14 and distal 16 ends with a lateral or y-axis and centerline 18 therebetween. For the purpose of describing this wrench, it is also useful to define this wrench as also having a longitudinal or x-axis 20 and a vertical or z-axis 22 with respect to the x-y-z orthogonal coordinate system whose origin is located at a point on the elongated rod's centerline that is proximate its proximal end. Additionally, we define this wrench as having an origin-located (i.e., it passes through the origin of the x-y-z orthogonal coordinate system that was defined to help describe the geometry of the wrench), transverse or horizontal plane that is characterized by it dividing this wrench into top 23a and bottom 23b portions (i.e., all the points in this transverse plane have a z-coordinate value of zero).

At the distal end of this rod is a handle 24 that extends perpendicular to the rod's lateral axis. As oriented in the embodiment shown in FIG. 3, the centerline 26 of this handle also lies in the previously defined, origin-located, transverse plane of this tool.

At the proximal end of this rod is a portion of it that is configured as a male, left-handed, threaded extraction head 28 which is seen to be tapered inward towards its centerline along its lateral axis from its attached end 30 to its free end 32. The outer surface 34 of this extraction head has a plurality of equally spaced-apart, quasi-helical ridges 36 that extend between the free and attached ends of this extraction head and between which exists corresponding grooves 38.

We'll see later that the use of these quasi-helical ridges 36 (as opposed to symmetric, helical ridges—the ridges of the present invention are quasi-helical because they have “deviation regions” or “spoons” at various, specific points along their length) is a necessary and unique aspect of the present invention and that they allow it to be made from low-cost manufacturing methods.

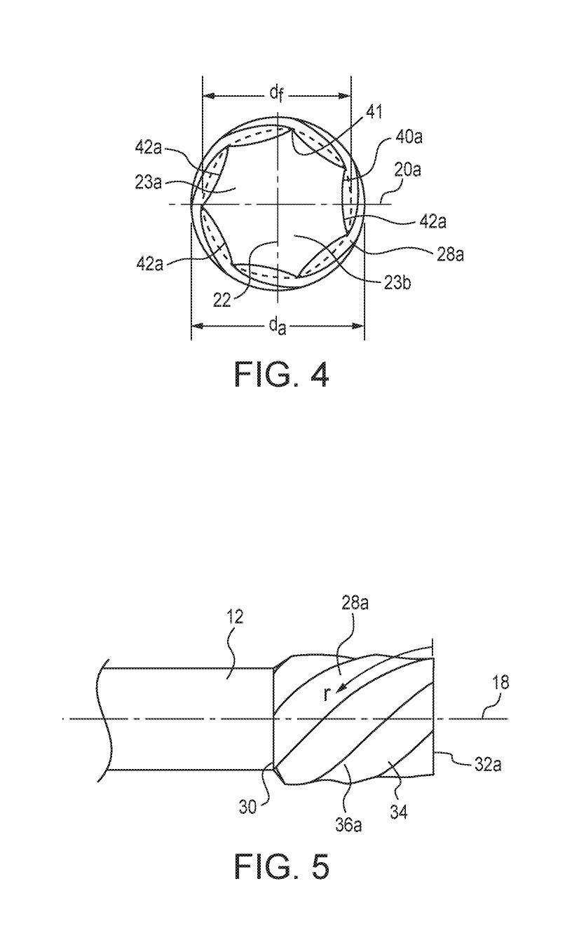

The extraction head of the embodiment shown in FIGS. 2, 3 and 4 has seven, quasi-helical ridges and corresponding grooves that wrap around the outer surface 34 of the head as each of these ridges extends from the head's free end to its attached end. Thus, in a free-end view of this embodiment, it would be seen that the perimeter 40 of this free end is composed of seven sides that are equal-length, arc segments having concave curvature 42. See FIG. 4. The geometry of the free end can be said to be characterized in part by the “free-end diameter, d_{f}” of the circle that includes the head's attached end can be said to be characterized in part by the “attached-end diameter, dₐ” of the circle that includes the seven arc segments, and intersection points of the attached end. Because of the extraction head's taper, the “attached-end diameter” is greater than the “free-end diameter,” dₐ>d_{f}. The amount of the taper on the extraction head ([dₐ−d_{f}]/length of extraction head) is typically in the range of 5-40 percent, and more particularly in the range of 10-25 percent over the length of extraction head.

The geometry of this extraction head and its quasi-helical ridges are unique in that they have been configured: (a) so as to allow the extraction head of the present invention to be manufactured by a metal casting process rather than a more expensive machining process, and (b) with the necessary modifications to the geometry of this extraction head to accommodate the use of a casting manufacturing process while also being such as to not diminish the tool's nipple extraction capabilities

To understand the geometry of this extraction head and its quasi-helical ridges, it proves useful to first examine the geometry of a stylized, symmetrical-around-its-perimeter extraction head 28a that has symmetric, and uniform-at-any-point-along-their-length, helical ridges 36a and grooves 38a, and thus is similar to the geometry of the free end of the present invention. See FIGS. 4 and 5.

To clarify what we mean by these helical ridges and grooves being “uniform-at-any-point-along-their-length,” see in FIG. 5 the parameter “r” which we define as a “ridge coordinate or r-coordinate” which travels along the top of a helical ridge and at any point along its path measures the distance of that point from the extraction head's free end. At any point along this path of this ridge, we can also think of taking a cross-sectional view of the ridge (i.e., a view that is perpendicular to the direction of movement of the r-coordinate). For the stylized extraction head shown in FIGS. 4 and 5, we find that this cross-section view of the ridge is constant or always the same, and we thus say that these helical ridges and grooves are “uniform-at-all-points-along-their-length.”

Therefore, when we have a somewhat similarly shaped extraction head whose having quasi-helical ridges 36 and grooves 38.

After considerable, experimental efforts with various “free end 32” geometries in an attempt to find one that would allow the present invention to be manufactured by a casting process and without diminishing the tool's extraction capabilities, it was found optimum to provide the extraction head's free end with a perimeter which is composed of either 5, 7, or 9 equal-length, arc segments, preferably with 7 (assuming that the tool is going to be used for removing the nipples that have broken from ½-¾ inch pipes with standard NPT threads: i.e., the numbers of sides could increase for removing nipples that have broken from larger diameter pipes). Meanwhile, for wrench's that are sized as above indicated, the wavelength of the extraction head's quasi-helical ridges is typically in the range of 0.5-3.5 inches, and more particularly in the range of 1.5-2.5 inches (e.g., if a quasi-helical ridge emanates from the head's free end at a point that is in the transverse plane of the head and the ridge is heading in a direction where it's z-coordinate will be negative, it will, after passing 360 degrees around the extraction head, again pass through this transverse plane and in a similar direction when its y-coordinate will have a value in the range of 1.5-2.5 inches).

Additionally, this free end was further configured so that when it is viewed looking along its longitudinal axis, the two arc segments 42a that are oriented the furthest to the left in FIG. 4 are seen to come together and join at a point that lies in the tool's origin-located, transverse plane [i.e., characterized by all of the points in this horizontal plane having a z-coordinate value of zero; it is partially represented in FIG. 4 by the longitudinal axis 20a]. This orientation of the tool (with respect to the x-y-z coordinate system that is used to define it) also results in this origin-located, transverse plane intersecting the free end's perimeter on its right side at a point that bisects its furthest-to-the-right-located, arc segment.

For those knowledgeable of the various casting processes used to manufacture an item, it can be seen in FIG. 4 that casting this stylized, extraction head with a 2-part, casting form (i.e., top and bottom parts that interface on the head's origin-known as its “backdraft.”

An example of this can be seen if we examine a portion of the path that a point on the free end's perimeter makes as it travels on a 360-degree loop around the free end's perimeter (note: this situation will also exists at any perpendicular, cross-sectional section (i.e., all points in such a section will have the same y value) we take through the extraction head at different values of y from the origin of the x-y-z coordinate system we are using to describe the geometry of the extraction head). The portions of this perimeter path that are of concern are the regions on either side of the head when this perimeter point passes through the head's origin-located, transverse plane. Alternatively, we could describe these regions of concern as possibly occurring when the r-coordinate that marks the location along a quasi-helical ridge passes through the extraction head's origin-located, transverse plane.

A “backdraft” problem is seen to occur on the right-hand side of FIG. 4 as this perimeter point rises above the head's origin-located, transverse plane and when it is also continuing to move further away from the center (i.e., x=0 & z=0) or lateral centerline of the head's free end. The result of this perimeter geometry will be that when the top part of the casting form is moved upward to get access to the newly cast extraction head, it will tear off this “backdraft” portion which is adjacent to the head's origin-located, transverse plane.

Further examination of this stylized extraction head, along its lateral axis, reveals that these “backdraft” portions can extend over the extraction head's entire length between its free and attached ends and on both its right and left sides.

To prevent such “backdraft” portion, breaking problems in a cast version of the present invention, the 2-part casting forms that are used to make the present invention were configured to provide this tool with quasi-helical ridges 36 and grooves 38 (i.e., somewhere along their above-defined, r-coordinate, the ridge's shapes stop being uniform) rather than the typical helical ridges and grooves that are sometimes seen on extraction tools.

To further prevent a problem with the diminishment of the tool's extraction regions in which they are being modified (so as to eliminate these backdraft problems) result in taking away only an approximate minimum volume of material to the shape of the extraction head from what it would have had with actual helical ridges and grooves.

Careful testing of various size embodiments of the present invention has shown that they can indeed be configured with the geometry described above so that they do not exhibit diminished, nipple extraction capabilities when they are manufactured using a 2-part, casting process.

For example, a prototype extraction head (that was configured to have a seven arc segment, free end with the tool's transverse plane intersecting one of its sides at an arc segment junction and the other side so as to bisect an arc segment, and with a free end diameter of 9/16 inch, an attached end diameter of ¾ inch, a length of 1 inch, and with seven pairs of left-handed, quasi-helical ridges and grooves for which the height between the top of a ridge and the bottom of its corresponding groove is in the range of 1/64- 1/16 inch, and with each ridge originating from one of the free end junctions or intersection points 41 of its arc segments, and with each quasi-helical ridge completing a loop around the extraction head over a longitudinal length of approximately 2 inches, i.e., the wavelength of said quasi-helical ridge is approximately 2 inches) was found to have no appreciable diminishment of its ability to extract nipples (that were originally the ends of a ½ inch diameter shower arm with NPT pipe threads) from an appropriately-sized, standard shower elbow.

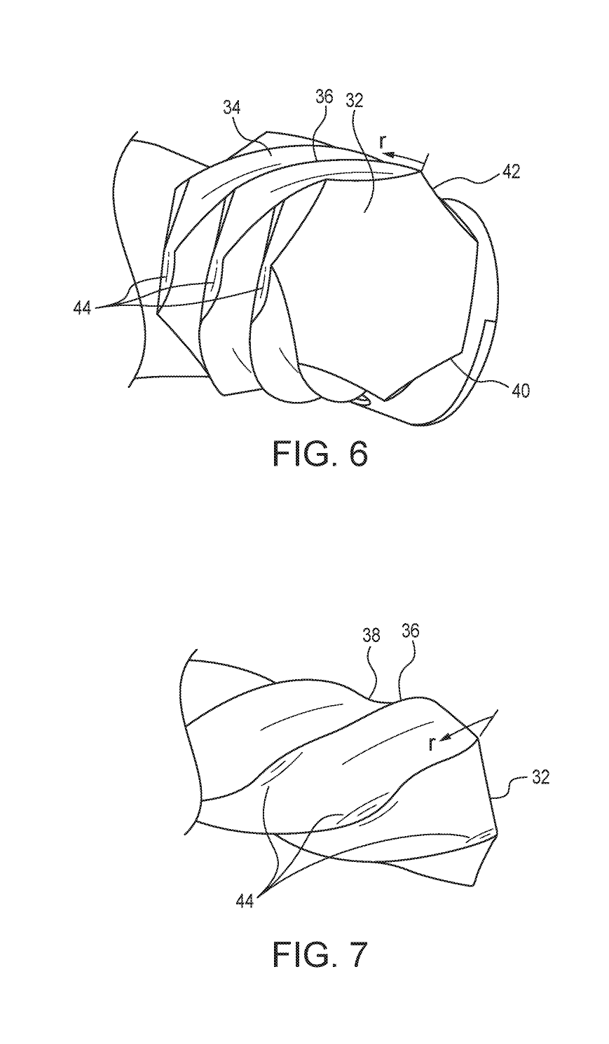

FIGS. 6-7 show in more detail a preferred embodiment for an extraction head of the present invention that has seven pairs of left-handed, quasi-helical ridges and grooves. Each of these pairs of quasi-helical ridges and grooves is actually seen to have a constant or uniform cross-sectional shape for a large portion of their length along its r-coordinate path.

The lengths along this r-coordinate where the ridge's cross-sectional shape differs from its otherwise uniform cross-sectional shape is seen to occur in those “deviation regions” or “spoons” 44 that are adjacent to when this r-coordinate passes upward through the extraction head's origin-located, transverse plane.

On the left-hand side of the extraction head shown in FIGS. 6-7, these “deviation regions” or “spoons” are seen to be located just below the head's origin-located, transverse plane. FIG. 7 also shows why these “deviation regions” are called “spoons,” i.e., because the geometry of these “deviation regions” or areas looks almost like someone has just used a spoon and taken off the top part of the ridge and with this taking off beginning at the point when the ridge passes below or above the head's origin-located, transverse plane as the ridge progresses from the head's free end to its attached end.

The width of this spooned area extends out to approximately the center of the adjoining grooves and down to the depths of these grooves and occurs over a length that is in the range of 1/10-⅛ of the length required for this helix to make a 360 degree turn around the outer surface of the extraction head. In actuality, what is being spooned off is essentially the backdraft areas that would have been broken off when opening the 2-part cast used to manufacture such a tool.

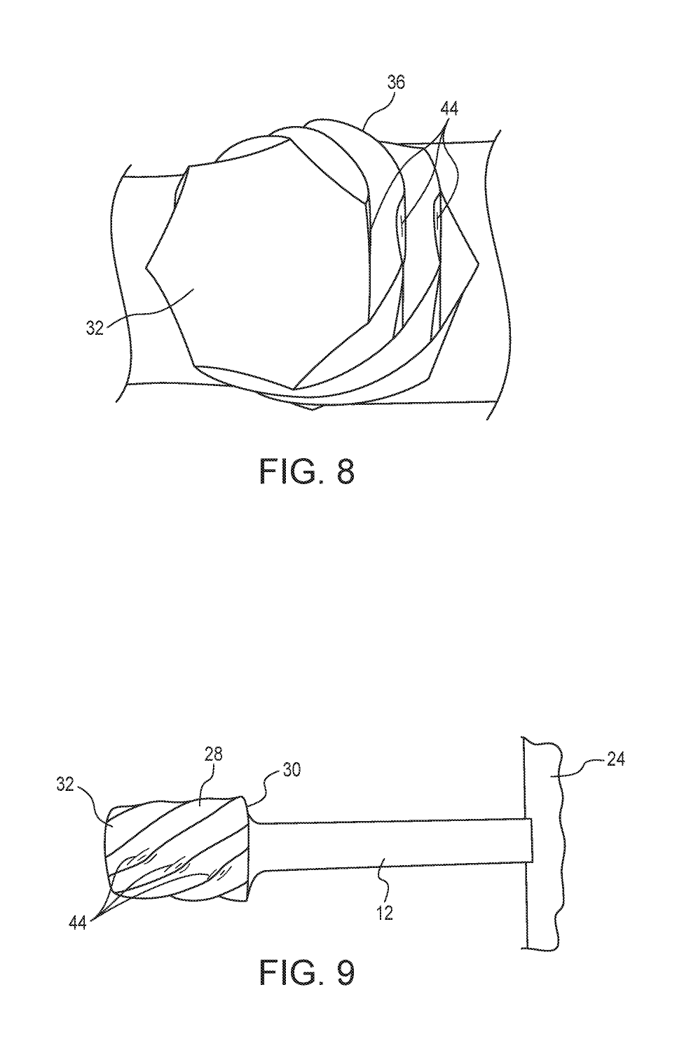

On the right-hand side of the extraction head shown in FIGS. 8-9, these “deviation regions” or “spoons” are seen to be located just above the head's origin-located, transverse plane and to have approximately the same, previously-described geometry as those regions that lie below the origin-located, transverse plane.

Since numerous modifications and changes will readily occur to those skilled in the art, it is not desired to limit the invention to the exact construction and operation shown and described herein. Accordingly, all suitable modifications and equivalents may be resorted to, falling within the scope of the invention that will later be set forth in the claims to the invention.

1. A wrench for extracting a broken nipple portion of what had been a threaded, male connector that had been screwed into a threaded, female, piping connector, said wrench comprising:
an elongated rod having proximal and distal ends,
an extraction head having an outer surface with a free end and an attached end that is attached to the proximal end of said elongated rod, said extraction head also having a top portion and a bottom portion that are separated by a transverse plane, and said extraction head further having a lateral centerline that extends between said attached and free ends,
wherein said free end has a perimeter that consists of a plurality of sides that are joined together at a plurality of intersection points,
wherein said outer surface has a plurality of quasi-helical ridges, each of which emanates from one of said plurality of intersection points on said free end and winds itself in a left-handed, tapering outward manner around said outer surface between said free end and said attached end of said extraction head, and
wherein each of said quasi-helical ridges has a deviation region adjacent to the points where one of said quasi-helical ridges both passes upward through said transverse plane and also moves further from said lateral centerline of said extraction head.

2. The wrench as recited in claim 1, further comprising:
a handle attached to said distal end of said elongated rod, said handle having a centerline that is oriented perpendicular to said lateral centerline of said extraction head.

3. The wrench as recited in claim 1, wherein:
said quasi-helical ridges are further configured so as to facilitate the gripping of said nipple by said outer surface of said extraction head.

4. The wrench as recited in claim 2, wherein:
said quasi-helical ridges are further configured so as to facilitate the gripping of said nipple by said outer surface of said extraction head.

5. The wrench as recited in claim 1, wherein:
said perimeter of said free end is configured so that the points where said perimeter passes through said transverse plane include an intersection point for two of the sides of said perimeter and a point that bisects another of said plurality of sides that are joined together to form said perimeter.

6. The wrench as recited in claim 2, wherein:
said perimeter of said free end is configured so that the points where said perimeter passes through said transverse plane include an intersection point for two of the sides of said perimeter and a point that bisects another of said plurality of sides that are joined together to form said perimeter.

7. The wrench as recited in claim 3, wherein:
said perimeter of said free end is configured so that the points where said perimeter passes through said transverse plane include an intersection point for two of the sides of said perimeter and a point that bisects another of said plurality of sides that are joined together to form said perimeter.

8. The wrench as recited in claim 4, wherein:
said perimeter of said free end is configured so that the points where said perimeter passes through said transverse plane include an intersection point for two of the sides of said perimeter and a point that bisects another of said plurality of sides that are joined together to form said perimeter.

9. The wrench as recited in claim 1, wherein:
each of said plurality of sides that are joined together to form said perimeter is an equal-length, arc segment having concave curvature.

10. The wrench as recited in claim 2, wherein:
each of said plurality of sides that are joined together to form said perimeter is an equal-length, arc segment having concave curvature.

11. The wrench as recited in claim 4, wherein:
each of said plurality of sides that are joined together to form said perimeter is an equal-length, arc segment having concave curvature.

12. The wrench as recited in claim 8, wherein:
each of said plurality of sides that are joined together to form said perimeter is an equal-length, arc segment having concave curvature.

13. The wrench as recited in claim 1, wherein:
said outward taper on said quasi-helical ridges of said extraction head is in the range of 10-25 percent.

14. The wrench as recited in claim 2, wherein:
said outward taper on said quasi-helical ridges of said extraction head is in the range of 10-25 percent.

15. The wrench as recited in claim 4, wherein:
said outward taper on said quasi-helical ridges of said extraction head is in the range of 10-25 percent.

16. The wrench as recited in claim 8, wherein:
said outward taper on said quasi-helical ridges of said extraction head is in the range of 10-25 percent.

17. The wrench as recited in claim 1, wherein:
the number of said quasi-helical ridges emanating from said plurality of intersection points on said perimeter of said free end of said extraction head is chosen from the group of 5, 7 and 9 quasi-helical ridges, and
the wavelength of said quasi-helical ridges on said extraction head is in the range of 1.5-2.5 inches.

18. The wrench as recited in claim 2, wherein:
the number of said quasi-helical ridges emanating from said plurality of intersection points on said perimeter of said free end of said extraction head is chosen from the group of 5, 7 and 9 quasi-helical ridges, and
the wavelength of said quasi-helical ridges on said extraction head is in the range of 1.5-2.5 inches.

19. The wrench as recited in claim 4, wherein:
the number of said quasi-helical ridges emanating from said plurality of intersection points on said perimeter of said free end of said extraction head is chosen from the group of 5, 7 and 9 quasi-helical ridges, and
the wavelength of said quasi-helical ridges on said extraction head is in the range of 1.5-2.5 inches.

20. The wrench as recited in claim 8, wherein:
the number of said quasi-helical ridges emanating from said plurality of intersection points on said perimeter of said free end of said extraction head is chosen from the group of 5, 7 and 9 quasi-helical ridges, and
the wavelength of said quasi-helical ridges on said extraction head is in the range of 1.5-2.5 inches.
